(19) United States
(12) Patent Application Publication
(10) Pub. No.: US 2015/0219910 A1
(43) Pub. Date: Aug. 6, 2015

(54) DISPLAY DEVICE AND DRIVING METHOD OF THE SAME

(71) Applicant: SAMSUNG DISPLAY CO., LTD., Yongin-City (KR)

(72) Inventors: HYEON YONG JANG, Hwaseong-si (KR); KANG-MIN KIM, Hwaseong-si (KR); JEONG MIN SUNG, Suwon-si (KR); SUNG WOO LEE, Anyang-si (KR); HYUNG WOO YIM, Goyang-si (KR)

(21) Appl. No.: 14/472,807

(22) Filed: Aug. 29, 2014

(30) Foreign Application Priority Data
Feb. 4, 2014 (KR) 10-2014-0012622

(51) Int. Cl. G02B 27/22; G02F 1/133; G02F 1/1347

(52) U.S. Cl. CPC G02B 27/2214; G02F 1/13471; G02F 1/13306

(57) ABSTRACT

A display device according to an exemplary embodiment of the present invention includes: a display panel configured to display an image; and a liquid crystal lens panel operated in one of a 2D mode or a 3D mode for the image of the display panel to be recognized as a 2D image or a 3D image. The liquid crystal lens panel includes a lower substrate and an upper substrate facing each other, a lower lens electrode formed on a lower substrate, an upper lens electrode formed on the upper substrate, and a liquid crystal layer interposed between the lower substrate and the upper substrate. When the liquid crystal lens panel is converted from the 2D mode to the 3D mode, the voltage applied to the upper lens electrode of the liquid crystal lens is applied while being increased in stages.

### CROSS-REFERENCE TO RELATED APPLICATION

This application claims priority to and the benefit of Korean Patent Application No. 10-2014-0012622 filed in the Korean Intellectual Property Office on Feb. 4, 2014, the disclosure of which is incorporated by reference herein.

### BACKGROUND

(a) Technical Field

The present invention relates to a display device and a driving method thereof.

(b) Discussion of Related Art

A display device typically displays a two dimensional (2D) image. However, there is great demand for a display capable of a displaying a three dimensional (3D) stereoscopic image, especially in fields such as gaming and movies.

A stereoscopic image display device divides an image into a left-eye image and a right-eye image having binocular disparity, and respectively provides them to a left eye and a right eye of an observer. The observer recognizes the left-eye image and the right-eye image through two eyes, and the images are combined in the brain thereby perceiving stereoscopicity.

A linear polarization type of stereoscopic display device divides an image into the left-eye image and the right-eye image by using stereoscopic spectacles (glasses). However if the spectacles are not worn properly, it can be difficult for an observer to perceive a 3D stereoscopic image.

A display method that does not involve wearing of spectacles can be used to perceive a 3D stereoscopic image. In this method, an element is used to divide the image for each direction, and accordingly, the method does not involve wearing of spectacles. This method is divided into a lenticular type, a parallax type, an integral photography type, and a holography type.

A lens used in the lenticular type may be a convex lens or a Fresnel lens. The Fresnel lens has a thinner thickness than the convex lens. The Fresnel lens has a plurality of circular arcs on a surface thereof. The Fresnel lens refracts light at the circular arcs.

### SUMMARY

A display device according to an exemplary embodiment of the present invention includes: a display panel configured to display an image; and a liquid crystal lens panel operated in one of a 2D mode to enable perception of the image as a 2D image and a 3D mode to enable perception of the image as a 3D image. The liquid crystal lens panel includes a lower substrate and an upper substrate facing each other, a lower lens electrode formed on a lower substrate, an upper lens electrode formed on the upper substrate, and a liquid crystal layer interposed between the lower substrate and the upper substrate. When the liquid crystal lens panel is converted from the 2D mode to the 3D mode, a voltage applied to the upper lens electrode of the liquid crystal lens is increased in stages.

The display panel may be one of a liquid crystal display (LCD) panel, an electrophoretic display panel (EDP), an organic light emitting display (OLED) panel, and a plasma display panel (PDP).

The lower lens electrode may be divided into a plurality of lower lens electrode groups, a width of each lower lens electrode in one lower lens electrode group may be gradually widen from a boundary of the lower lens electrode group to a center, and the upper lens electrode may be formed of one plate.

The liquid crystal lens panel may include a DC-DC convertor formed on one side of the lower substrate, and a plurality of driving ICs connected to the DC-DC convertor, wherein the plurality of driving ICs may be connected to the lower lens electrode and the upper lens electrode.

The DC-DC convertor may supply a voltage to the lower lens electrode and a common voltage to the upper lens electrode, and an external signal may be applied to a feedback terminal positioned on one side of the DC-DC convertor to gradually increase the common voltage applied to the upper lens electrode in the DC-DC convertor.

The liquid crystal lens panel may include a voltage controller connected to the feedback terminal of the DC-DC convertor, and the voltage controller may output different logic signals according to the 2D mode or the 3D mode to be supplied to the DC-DC convertor.

The voltage controller may output the logic high signal in the 2D mode to suppress the output of the common voltage of the DC-DC convertor, and the voltage controller may output the logic low signal in the 3D mode to output the common voltage through the DC-DC convertor.

When the voltage controller converts the liquid crystal lens from the 2D mode into the 3D mode, the DC-DC convertor may increase the common voltage applied to the upper lens electrode in stages by using a pulse width modulation method (PWM).

In an exemplary embodiment, the liquid crystal lens does not apply the voltage to the upper lens electrode and the lower lens electrode of the liquid crystal lens in the 2D mode, and a different voltage is applied to each lower lens electrode included in the lower lens electrode group of the lower lens electrode and the common voltage of a predetermined magnitude is applied to the upper lens electrode in the 3D mode.

When the voltage controller performs the mode conversion from the 2D mode to the 3D mode, the DC-DC convertor may linearly increase the common voltage applied to the upper lens electrode by using the pulse width modulation method (PWM).

A driving method of a display device according to an exemplary embodiment of the present invention includes: generating a conversion signal converting a display device from a 2D image mode to a 3D image mode; applying the conversion signal to a DC power source unit and a voltage controller of the liquid crystal lens panel; turning on the DC power source unit of the liquid crystal lens applied with the conversion signal and supplying the DC power source to a DC-DC convertor; modulating a logic high signal into a logic low signal in the voltage controller applied with the conversion signal by using a pulse width modulation method; supplying the modulated signal to the DC-DC convertor through the feedback terminal of the DC-DC convertor; gradually increasing an output of the DC-DC convertor supplied with the modulated signal to generate a common voltage that is gradually increased; passing the common voltage formed in the DC-DC convertor through a current amplifier; and supplying the common voltage passing through the current amplifier to the upper lens electrode.

The DC power source supplied from the DC power source unit to the DC-DC converter may be in a range from 11 V to 13 V.

The common voltage generated in the DC-DC convertor may be increased with a step shape.

The common voltage generated in the DC-DC convertor may be increased with a linear shape.

The common voltage that is finally formed in the DC-DC convertor may be a middle voltage between a lowest voltage and a highest voltage that are applied to the liquid crystal lens panel.

The modulating of the logic high signal into the logic low signal in the voltage controller applied with the conversion signal by using a pulse width modulation method may include forming the logic high signal or the logic low signal of a digital signal in a control signal generator located within the voltage controller, and converting the digital signal into an analog signal in a low pass filter connected to the control signal generator.

A display device and A driving method thereof according to at least one embodiment of the present invention positions a liquid crystal lens on the display panel such that one of the 2D image and the 3D image are displayable according to whether the liquid crystal lens is on or off. For example, when the liquid crystal lens is changed from an off state to an on state, by applying a common voltage of an upper lens electrode of the liquid crystal lens in stages, an overload may be prevented.

A display device according to an exemplary embodiment of the present invention includes: a display panel configured to display an image; and a liquid crystal lens panel operated in one of a two dimensional (2D) mode to enable perception of the image as a 2D image and a 3D mode to enable perception of the image as a 3D image. The liquid crystal lens panel includes: a lower substrate and an upper substrate facing each other; a lower lens electrode formed on the lower substrate; an upper lens electrode formed on the upper substrate, and a liquid crystal layer interposed between the lower substrate and the upper substrate. When the liquid crystal lens panel is operated in the 2D mode, a first voltage of a constant level is applied to the upper lens electrode. When the liquid crystal lens panel is switched from the 2D mode to a 3D mode, a second voltage that increases linearly with time from the constant level is applied to the upper lens electrode.

In an embodiment, the upper lens electrode is shaped as a single plate, and the lower lens electrode includes a plurality of separate elements spaced apart from one another. In an embodiment, an area of the upper lens electrode corresponds to an entire screen area of the display panel. In an embodiment, the separate elements include: a first plurality of lens electrodes with gradually increasing widths; and a second plurality of lens electrodes with gradually increasing widths disposed on the first plurality of lens electrodes.

### BRIEF DESCRIPTION OF THE DRAWINGS

FIG. 1 is a view of a display device according to an exemplary embodiment of the present invention.

FIG. 2A shows a structure of a general Fresnel lens.

FIG. 2B is an enlarged view of a portion indicated by a dotted line in FIG. 2A.

FIG. 2C is a view of a liquid crystal lens according to an exemplary embodiment of the present invention.

FIG. 3 is a cross-sectional view and a layout view of a lower lens electrode of a liquid crystal lens according to an exemplary embodiment of the present invention,

FIG. 4A is a view of a common voltage application method of an upper lens electrode of a liquid crystal lens according to an exemplary embodiment of the present invention.

FIG. 4B is a view of a charge current of an upper lens electrode when applying a common voltage.

FIG. 5A is a view of a common voltage application method of an upper lens electrode of a liquid crystal lens according to a comparative example of the present invention.

FIG. 5B is a view of a charge current of an upper lens electrode when applying a common voltage.

FIG. 6 is a multi-step common voltage generation circuit diagram according to an exemplary embodiment of the present invention.

FIG. 7 is a view of a control signal generated in a control signal generator when converting a liquid crystal lens from a 2D mode into a 3D mode.

FIG. 8 is a view of a current flowing to a power source controller when converting a liquid crystal lens from a 2D mode into a 3D mode.

FIG. 9 is a view of a voltage applied to an upper lens electrode when converting a liquid crystal lens from a 2D mode into a 3D mode.

FIG. 10 is a common voltage generation circuit diagram of a single step according to a comparative example of the present invention.

FIG. 11 is a view of a control signal generated from a control signal generator when converting a liquid crystal lens from a 2D mode into a 3D mode.

FIG. 12 is a view of a current flowing to a power source controller when converting a liquid crystal lens from a 2D mode into a 3D mode.

FIG. 13 is a view of a voltage applied to an upper lens electrode when converting a liquid crystal lens from a 2D mode into a 3D mode.

FIG. 14 is a view of a voltage applied to an upper lens electrode when converting a liquid crystal lens from a 2D mode into a 3D mode.

FIG. 15 is a view of a liquid crystal lens panel according to an exemplary embodiment of the present invention.

FIG. 16 is a flowchart of a voltage application method of an upper lens electrode of a liquid crystal lens.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present.

A driving method of a display device according to an exemplary embodiment of the present invention will be described with reference to accompanying drawings.

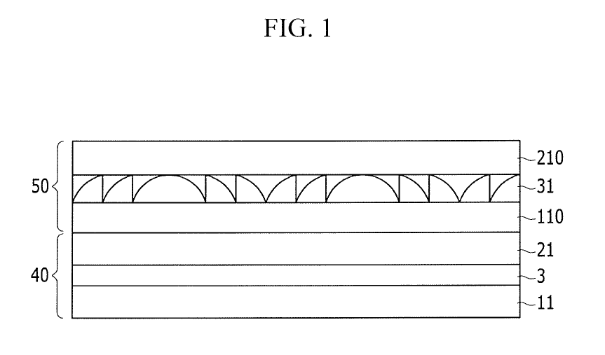

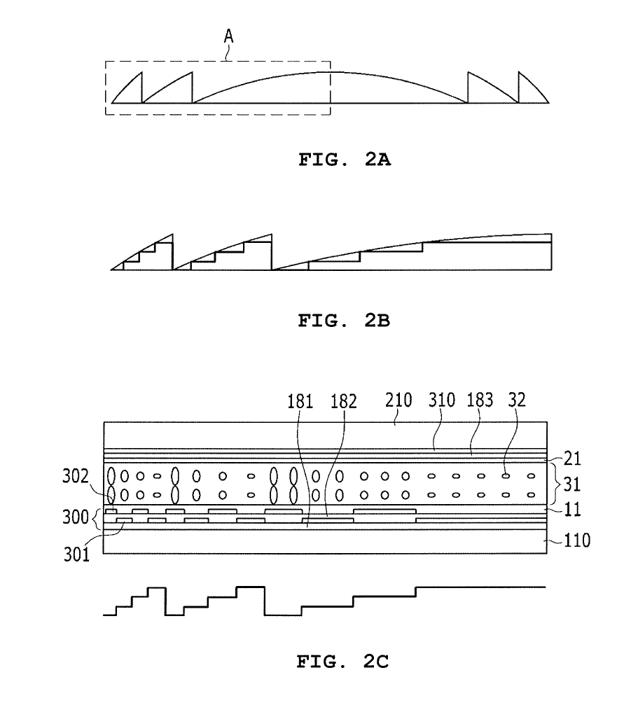

Firstly, a display device according to an exemplary embodiment of the present invention will be described with reference to FIG. 1, FIG. 2A, FIG. 2B, and FIG. 2C. FIG. 1 is a view of a display device according to according to an exemplary embodiment of the present invention.

Referring to FIG. 1, a display device according to an exemplary embodiment of the present invention includes a display panel 40 and a liquid crystal lens panel 50 positioned on the display panel 40.

The display panel 40 may be various display panels such as a liquid crystal display (LCD) panel, an electrophoretic display panel (EDP), an organic light emitting display (OLED) panel, and a plasma display panel (PDP). In the present exemplary embodiment, as an example of the display panel 40, the liquid crystal display (LCD) panel is described.

The display panel 40 includes a first substrate 11 and a second substrate 21 facing each other, and a liquid crystal layer 3 positioned between the substrates. Liquid crystal molecules are aligned according to a voltage potential applied to electrodes formed on the first substrate 11 and the second substrate 21, thereby displaying images.

The first substrate 11 includes a plurality of pixel areas. In each pixel area, a gate line (not shown) extending in a first direction, a data line (not shown) extending in a second direction intersecting the first direction and insulated from the gate line, and a pixel electrode (not shown) are formed. Also, in each pixel, a thin film transistor (not shown) electrically connected to the gate line and the data line and electrically connected to the corresponding pixel electrode is provided. The thin film transistor provides a driving signal to a side of the corresponding pixel electrode. Also, a driver integrated circuit (IC) (not shown) may be formed on one side of the first substrate 11. In an embodiment, the driver IC receives various control signals from an external source, and outputs the driving signal driving the display panel 40 to a side of the thin film transistor in response to the various input control signals.

The second substrate 21 may include red, green, blue (RGB) color filters realizing predetermined colors by using light provided from a backlight unit (not shown) on one surface, and a common electrode (not shown) formed on the RGB color filters and facing the pixel electrode. Here, the RGB color filters may be formed through a thin film process. In an exemplary embodiment of the present invention, the color filters are formed on the second substrate 21, but the invention is not limited thereto. For example, the color filters may be formed on the first substrate 11. Further, the common electrode of the second substrate 21 may be formed on the first substrate 11.

Liquid crystal molecules of the liquid crystal layer 3 are arranged in a predetermined orientation by the voltage applied to the pixel electrodes and the common electrode such that transmittance of the light provided from the backlight unit is changed, thereby displaying the image through the display panel 40. When the backlight unit is omitted, the transmittance of the light incident to the front surface of the display panel and reflected is controlled, thereby displaying the images.

The liquid crystal lens panel 50 is positioned on the display panel 40. The liquid crystal lens panel 50 includes a lower substrate 110, an upper substrate 210 facing the lower substrate, and a liquid crystal layer 31 interposed between the lower substrate and the upper substrate.

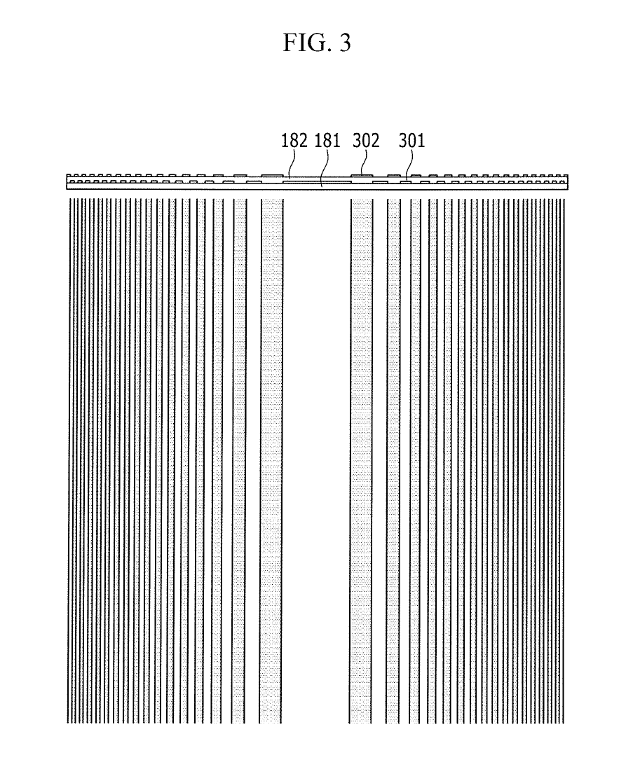

Referring to FIG. 2A, FIG. 2B, FIG. 2C and FIG. 3, an exemplary embodiment of a liquid crystal lens of the liquid crystal lens panel 50 will be described in detail.

FIG. 2A shows a structure of a general Fresnel lens, and FIG. 2B is an enlarged view of a portion indicated by a dotted line in FIG. 2A. Straight lines forming a step shape shown in FIG. 2B show a zone plate phase distribution. FIG. 2C is a view of a liquid crystal lens according to an exemplary embodiment of the present invention.

In an exemplary embodiment of the present invention, a lens electrode of the liquid crystal lens includes a lower lens electrode 300 made of a plurality of separate electrodes and an upper lens electrode 310 facing the lower lens electrode 300. The upper lens electrode 310 may be shaped as a plate. The upper lens electrode 310 and the lower lens electrode 300 are transparent. However, the upper lens electrode 310 may have an electrode structure that is similar to the lower lens electrode 300. For example, rather than the upper lens electrode 310 being shaped as a single plate, the upper lens electrode 310 can be comprised of several separate electrodes like the illustrated lower lens electrode 300.

FIG. 3 is a cross-sectional view and a layout view of a lower lens electrode 300 of a liquid crystal lens according to an exemplary embodiment of the present invention,

In the lower lens electrode 300, a plurality of branch electrodes (the first lens electrode and the second lens electrode) are disposed with a stripe shape. The branch electrodes are respectively disposed with a constant pattern, and one pattern forms one unit lens electrode. That is, FIG. 3 shows one unit lens electrode.

Referring to FIG. 3, one unit lens has a shape in which a width of the separate lens electrode is increased closer to the center thereof. This unit lens functions as a plate type of liquid crystal lens. The zone plate is referred to as a Fresnel zone plate, and realizes a lens effect by using a diffraction phenomenon. The liquid crystal lens of the display device in an exemplary embodiment of the present invention functions like the Fresnel lens since a plurality of separate electrodes are applied with different voltages, a common voltage is applied to the upper lens electrode 310, and the alignment degree of the liquid crystal molecules 32 is differently changed for each position of the lens electrode.

As shown in FIG. 2C, the liquid crystal lens in an exemplary embodiment of the present invention includes the lower substrate 110, the upper substrate 210 facing the lower substrate 110, and the liquid crystal layer 31 interposed between the lower substrate 110 and the upper substrate 210.

The first substrate 11 includes the lower substrate 110, a first insulating layer 181 formed on the lower substrate, a plurality of first lens electrodes 301, a second insulating layer 182, and a plurality of second lens electrodes 302. The second insulating layer 182 is disposed between the first lens electrodes 301 and the second lens electrodes 302 such that the first electrodes and the second electrodes are formed on different layers and are electrically insulated from each other. In an exemplary embodiment, the widths of each of the lens electrodes 301 and 302 gradually increase. In an exemplary embodiment, the first lens electrodes 301 do not overlap with the second lens electrodes 302. For example, when the electrodes 301 and 302 do not overlap, a lens electrode 301 starts where a lens electrode 302 ends, and ends where a new lens electrode 302 begins.

The first lens electrodes 301 and the second lens electrode 302 may include a transparent conductive oxide. For example, the first lens electrodes 301 and the second lens electrodes 302 may include indium tin oxide (ITO) or indium zinc oxide (IZO). Although not shown, the first lens electrodes 301 and the second lens electrodes 302 may be connected to a driving IC positioned on one side and may receive a voltage when the liquid crystal lens is turned on.

The first insulating layer 181 and the second insulating layer 182 include an insulating material that transmits light. For example, the first insulating layer 181 and the second insulating layer 182 may include a silicon nitride (SiNx) or a silicon oxide (SiOx). The first insulating layer 181 is formed on the lower substrate, the first lens electrodes 301 are formed on the first insulating layer 181, the second insulating layer 182 is formed on the first insulating layer 181 formed with the first lens electrodes 301, and the second lens electrodes 302 are formed on the second insulating layer 182. An alignment layer 11 may be positioned on the second lens electrodes 302.

The upper lens electrode 310 is formed on the upper substrate 210. The upper lens electrode 310 may include a transparent conductive oxide material. For example, the upper lens electrode 310 may include indium tin oxide (ITO) or indium zinc oxide (IZO). A passivation layer 183 and an alignment layer 21 may be positioned on the upper lens electrode 310. Although not shown, the upper lens electrode 310 may receive a common voltage Vcom of a predetermined magnitude from a driving IC positioned at one side. The common voltage Vcom applied to the upper lens electrode 310 may be between a lowest voltage VEE and a highest voltage VDD applied to the liquid crystal lens.

If the voltage is supplied to the upper lens electrode 310, the first lens electrodes 301, and the second lens electrode 302s, the liquid crystal molecules 32 of the liquid crystal layer 31 are rearranged. Accordingly, the first lens electrodes 301, the second lens electrodes 302, the upper lens electrode 310, and the liquid crystal layer 31 form the unit lens.

In an exemplary embodiment, the liquid crystal layer 31 has a thickness of 2 μm to 5 μm or about 2 μm to about 5 μm. The liquid crystal layer 31 has a thin thickness such that high speed switching according to the alignment of the liquid crystal molecules 32 may be realized. The liquid crystal layer 31 may be aligned to have a refractive index of a Fresnel lens by the first lens electrodes 301, the second lens electrodes 302, and the upper lens electrode 310.

If the driving voltage is applied to the liquid crystal lens, a voltage potential is generated between the first lens electrodes 301 and second lens electrodes 302, and the upper lens electrode 310, such that the liquid crystal molecules 32 of the liquid crystal layer 31 interposed between the first lens electrodes 301 and second lens electrodes 302, and the upper lens electrode 310, are rearranged. Accordingly, the unit lens may have the same phase difference as the Fresnel lens. Accordingly, when the liquid crystal lens is positioned on the display panel, a 3D stereoscopic image may be perceived by an observer without using spectacles or glasses.

When the liquid crystal lens in an exemplary embodiment of the present invention is not applied with the voltage, the liquid crystal molecules 32 of the liquid crystal layer 31 of the liquid crystal lens are not aligned, and thus a 2D image is perceived. However, when the liquid crystal lens is applied with the voltage, while the liquid crystal molecules 32 of the liquid crystal layer 31 of the liquid crystal lens are aligned, a 3D stereoscopic image is perceived. That is, while the liquid crystal lens in an exemplary embodiment of the present invention is positioned on the display device, one of a 2D image and a 3D image can be perceived.

When the liquid crystal lens is used to display the 3D image, the voltage is simultaneously applied or applied at substantially the same time to the lower lens electrode 300 and the upper lens electrode 310 of the liquid crystal lens. As shown in FIG. 2A, FIG. 2B, FIG. 2C and FIG. 3, the lower lens electrode 300 is made of a plurality of branch electrodes and the upper lens electrode 310 is made of one plate. As described above, each branch electrode of the lower lens electrode 300 is applied with the different voltage, and the upper lens electrode 310 is applied with the common voltage. In an exemplary embodiment, the applied common voltage Vcom is a middle voltage between the lowest voltage VEE and the highest voltage VDD applied to the lower lens electrode 300.

A driving method of the liquid crystal lens according to an exemplary embodiment of the present invention increases in stages and applies the common voltage to the upper lens electrode 310. That is, the common voltage of Vcom is not initially applied to the upper lens electrode 310, and the voltage is gradually increased from the lowest voltage VEE in stages and finally reaches the highest voltage Vcom.

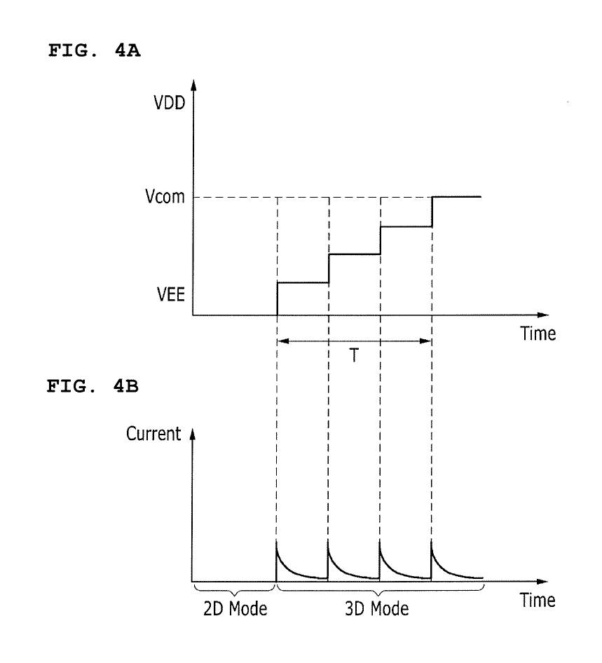

FIG. 4A is a view of a common voltage application method of an upper lens electrode (e.g., 310) of a liquid crystal lens according to an exemplary embodiment of the present invention, and FIG. 4B is a view of a charge current of an upper lens electrode (e.g., 310) when applying a common voltage.

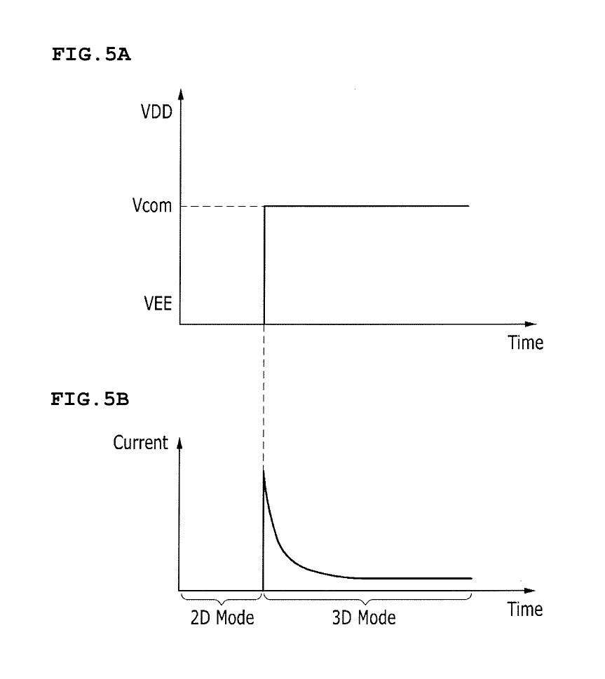

FIG. 5A is a view of a common voltage application method of an upper lens electrode of a liquid crystal lens according to a comparative example, and FIG. 5B is a view of a charge current of an upper lens electrode when applying a common voltage.

Referring to FIG. 4A, the driving method of the liquid crystal lens according to an exemplary embodiment of the present invention does not increase the common voltage Vcom of the upper lens electrode 310 instantly, but gradually increases and applies the voltage in stages over time. For example, as shown in FIG. 4A, the common voltage is VEE during a first period, then becomes a first voltage higher than VEE during a second period, then becomes a second voltage higher than the first voltage during a third period, then becomes a third voltage higher than the second voltage during a fourth period, and then becomes a common voltage higher than the third voltage during a fifth period. While FIG. 4A shows the common voltage Vcom being increased from its lowest value to its highest value gradually over a certain number of stages, the invention is not limited to any number of stages. In an exemplary embodiment, during each stage, the common voltage is constant or substantially constant.

The liquid crystal lens panel 50 may be considered off or deactivated when voltage VEE is applied to its upper lens electrode 310, and accordingly 2D images can be perceived. The liquid crystal lens panel 50 may be considered on or activated when voltage Vcom is applied to its upper lens electrode 310., and accordingly 3D images can be perceived.

Referring to FIG. 4B, the current flowing to the upper lens electrode 310 is increased every time the voltage is increased and appears as a peak. The driving method of the liquid crystal lens according to the present exemplary embodiment does not apply the voltage at one time, but changes and increases the voltage in stages, and a string of short peaks appear instead of one large current peak. That is, a large current does not flow to the upper lens electrode 310 at one time, but the current is dispersed and flows.

FIG. 5A and FIG. 5B show a driving method of a liquid crystal lens according to a comparative example. Referring to FIG. 5A, when the common voltage is applied to the upper lens electrode 310 of the liquid crystal lens at one time, an excessive current flows to the upper lens electrode 310 all at once. In a current-time graph shown in FIG. 5B, the current amount is suddenly increased when starting the operation of the 3D mode. Accordingly, one large current peak appears in FIG. 5B.

In the liquid crystal lens in an exemplary embodiment of the present invention, the lower lens electrode 300 is formed of a plurality of branch electrodes and the upper lens electrode 310 is formed as one plate. In an exemplary embodiment, an area of the upper lens electrode 310 corresponds to an entire screen area of the display panel. In an exemplary embodiment, the liquid crystal lens panel 50 functions as a capacitor (e.g., several hundred microfarads) such that an overload is generated when the common voltage is applied to the upper lens electrode 310, and the voltage is applied and simultaneously the liquid crystal lens electrode is driven such that the power of the driving IC is spent, thereby further increasing the load.

If the common voltage that transitions immediately from its lowest level it its highest level is applied to the upper lens electrode 310 of the liquid crystal lens, an overcurrent (e.g., excessive current) flows to the liquid crystal lens and the overload is generated. However, as shown in FIG. 4A and FIG. 4B, the driving method of the liquid crystal lens according to an exemplary embodiment of the present invention increases and applies the common voltage in stages such that the overload of the liquid crystal lens is prevented and the overcurrent is dispersed.

In an exemplary embodiment, an integral area of the current-time graph of FIG. 5B is the same as an integral area of the current-time graph of FIG. 4B. That is, in FIG. 5A and FIG. 5B, when converting the 2D image mode into the 3D image mode, the large overcurrent flows at one time and it is shown as one large peak in FIG. 5B. However, in FIG. 4B showing the current when driving the liquid crystal lens according to an exemplary embodiment of the present invention, a plurality of small peaks appear instead of one large peak. In an embodiment, a sum of the area shown in the graph of FIG. 4B is the same as a sum of the area shown in the graph of FIG. 5B. Accordingly, the driving method of the liquid crystal lens according to an exemplary embodiment of the present invention does not flow the overcurrent at one time, but disperses and flows the current.

In FIG. 4A, a time T in which the voltage reaches Vcom is several hundred milliseconds as an example. The time T is shorter than a minimum time that can be recognized so that a viewer does not perceive the step change of the voltage when the common voltage is applied in stages, but it is recognized that the 2D image is directly converted into the 3D stereoscopic image.

An exemplary method of applying the common voltage in stages in the driving method according to the liquid crystal lens of the present invention will be described with reference to

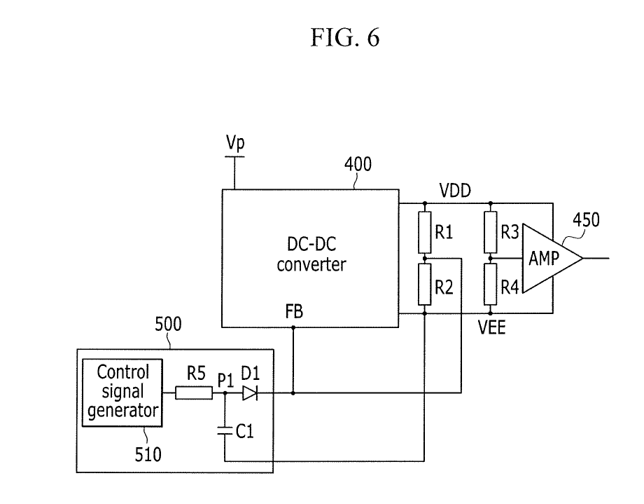

FIG. 6 to FIG. 10.

FIG. 6 is a multi-step common voltage generation circuit diagram according to an exemplary embodiment of the present invention.

Referring to FIG. 6, the multi-step common voltage generation circuit diagram according to an exemplary embodiment of the present invention includes a DC-DC convertor 400, resistors R1, R2, R3, and R4 connected to the DC-DC convertor 400, a current amplifier 450 connected to the resistors R3 and R4, and a voltage controller 500 connected to a feedback terminal FB of the DC-DC convertor 400.

Although not shown in FIG. 5A and FIG. 5B, the DC-DC convertor 400 is connected to a DC power source unit to receive a DC power source Vp.

The resistors R1 and R2 have a function to feed back a voltage output from the DC-DC convertor 400. That is, the resistors R1 and R2 are connected to the feedback terminal FB of the DC-DC convertor 400 to control the voltage output from the DC-DC convertor 400.

The resistors R3 and R4 divide the highest voltage VDD and the lowest voltage VEE to generate the common voltage. The generated common voltage is applied to the upper lens electrode 310 through the current amplifier 450.

In an exemplary embodiment of the present invention, the feedback terminal FB of the DC-DC convertor 400 is connected to the voltage controller 500. The voltage controller 500 includes a control signal generator 510, and may additionally include a resistor R5, a diode D1, and a capacitor C1.

The control signal generator 510 applies a logic high signal or a logic low signal to control the output voltage of the DC-DC convertor 400.

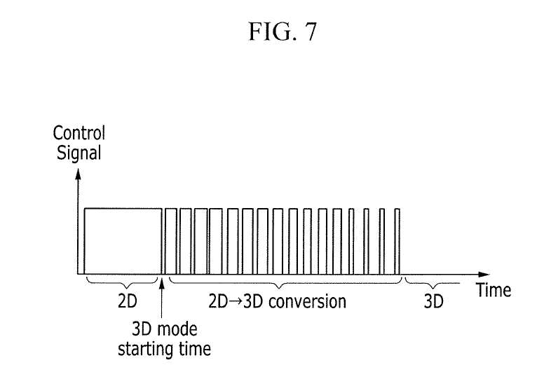

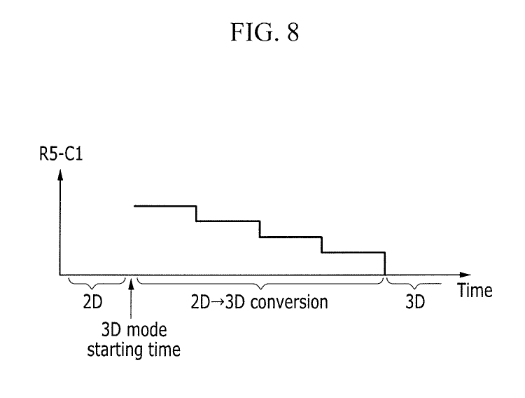

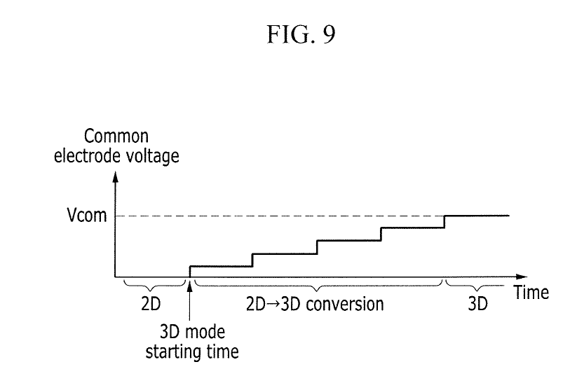

FIG. 7 shows the control signal generated from the control signal generator 510 when converting a liquid crystal lens from a 2D mode into a 3D mode. FIG. 8 shows the current flowing to the power source controller when converting a liquid crystal lens from a 2D mode into a 3D mode. FIG. 9 shows the voltage applied to the upper lens electrode 310 when converting a liquid crystal lens from a 2D mode into a 3D mode.

FIG. 7 shows the control signal generated from the control signal generator 510. When displaying the 2D image, the constant logic high signal is generated from the control signal generator 510. This signal is applied to the feedback terminal FB of the DC-DC convertor 400. Since the DC-DC convertor 400 receives the logic high signal it is recognized that the output voltage is high such that the voltage is not output. Accordingly, the electrode of the liquid crystal lens is supplied with the voltage and then the liquid crystal lens is not operated such that the 2D image is displayed.

However, when displaying the 3D stereoscopic image, the control signal generator 510 gradually changes the pulse through pulse width modulation (PWM) from a modulation ratio of 100% to the modulation ratio of 0%. For example, the control signal generator 510 may set the modulation ratio to a first value between 100% and 0% and maintain that first value for a first period of time, set the modulation ration to a second value between the first value and 0% and maintain the second value for a subsequent period, etc. FIG. 7 shows the pulse signal in which the modulation ratio is gradually decreased. The control signal output from the control signal generator 510 is gradually changed by the pulse width modulation method from a 3D starting time to the 3D image displaying time. The DC-DC convertor 400 receives the signal that is modulated from the logic high signal to the logic low signal through the feedback terminal FB. Accordingly, the DC-DC convertor 400 recognizes that the output voltage is gradually decreased such that the voltage is output while being gradually increased.

The signal having the pulse width that is modulated according to time is output from control signal generator 510, and passed through a low pass filter including the resistor R5, the diode D1, and the capacitor C1. FIG. 8 is a graph measuring the current flowing at node P1 of FIG. 6 according to time. That is, FIG. 8 shows a low pass component of the control signal passing through the low pass filter.

The control signal passing through the low pass filter is supplied to the DC-DC convertor 400. The DC-DC convertor 400 receives the control signal through the feedback terminal FB. Accordingly, in the 2D mode in which the constant logic high signal was applied, the voltage was output from the DC-DC convertor 400. However, during a process in which the logic high signal is gradually modulated into the logic low signal, the DC-DC convertor 400 recognizes that the output voltage is gradually decreased such that the output voltage is gradually increased. Accordingly, the common voltage that is increased in stages from the lowest voltage to Vcom is output.

FIG. 9 shows the voltage applied to the upper lens electrode 310 when converting a liquid crystal lens from a 2D mode into a 3D mode. Referring to FIG. 9, it may be confirmed that the voltage is gradually increased from the 3D mode starting time and reaches the Vcom.

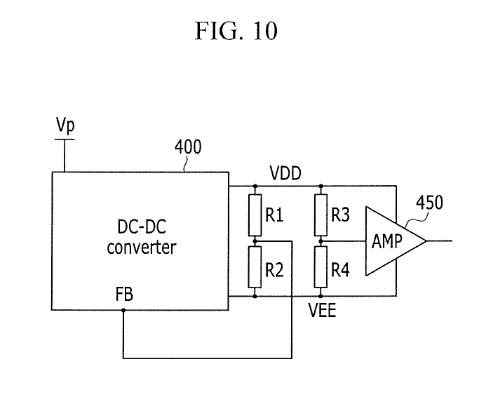

FIG. 10 is a common voltage generation circuit diagram of a single step according to a comparative example of the present invention. In FIG. 10, the voltage controller 500 is not shown. Accordingly, in the DC-DC convertor 400, the common voltage applied to the upper lens electrode 310 is not changed in stages. Therefore, to apply the common voltage Vcom applied to the upper lens electrode 310 of the liquid crystal lens in stages, an amplification ratio of the current amplifier 450 needs to be varied to be supplied. The current amplifier 450 needs to vary the amplification ratio such that an advanced current amplifier 450 is required.

When the common voltage Vcom is not applied in stages, but is applied at one time, a high voltage needs to be applied at one moment such that capacity of the DC power source unit needs to be large and capacity of the DC-DC converter needs to be large.

However, the driving method of the liquid crystal lens according to the present exemplary embodiment applies an external signal to the feedback terminal FB of the DC-DC convertor 400 to control the common voltage applied to the upper lens electrode 310 in stages in the DC-DC convertor 400. Therefore, an advanced current amplifier is not separately required. Also, the common voltage is applied in stages such that an overload is not generated and it is not necessary to increase the capacity of the DC power source unit or the DC-DC converter 400.

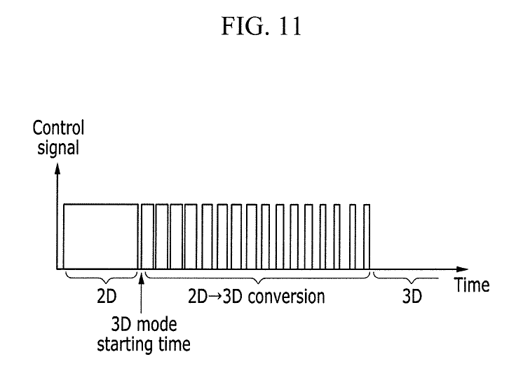

A driving method of the liquid crystal display according to an exemplary embodiment of the present invention will be described with reference to FIG. 11 to FIG. 14. Referring to FIG. 11 to FIG. 14, the driving method of the liquid crystal display according to FIG. 11 to FIG. 14 is similar to the driving method of the liquid crystal display according to FIG. 6 to FIG. 9. The detailed description of like constituent elements is omitted.

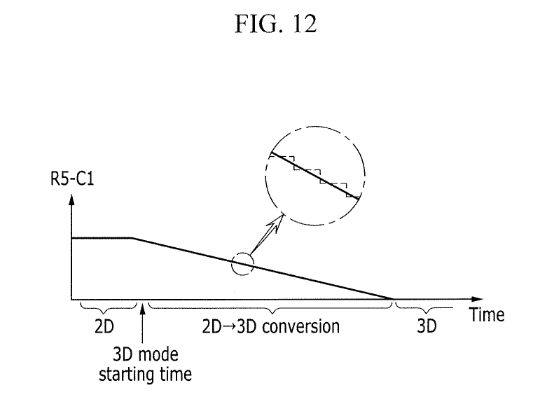

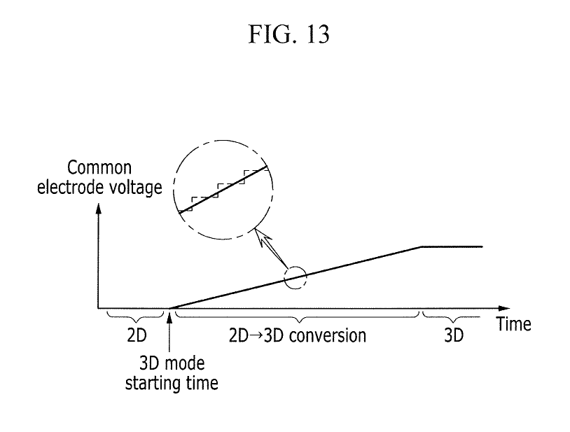

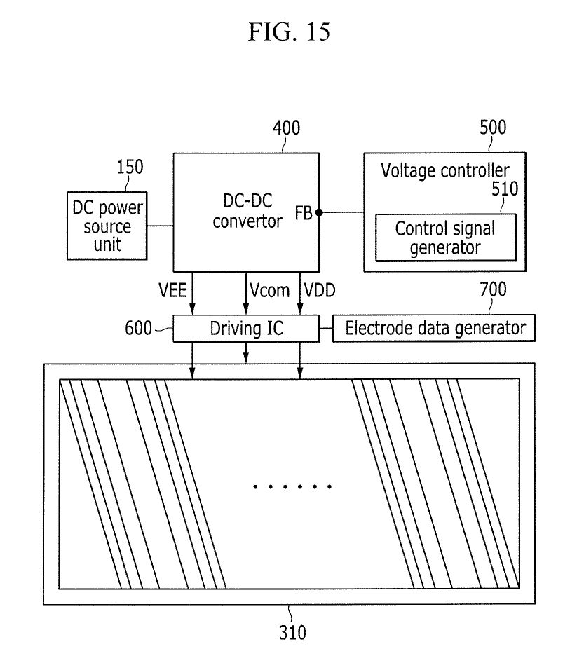

FIG. 11 shows the control signal generated in the control signal generator 510 when converting a liquid crystal lens from a 2D mode into a 3D mode. FIG. 12 shows the current flowing to the power source controller when converting a liquid crystal lens from a 2D mode into a 3D mode. FIG. 13 shows the voltage applied to the upper lens electrode 310 when converting a liquid crystal lens from a 2D mode into a 3D mode. FIG. 15 shows the charge current of the upper lens electrode 310 of the liquid crystal lens when applying the common voltage.

Referring to FIG. 11, as compared with FIG. 7, a step change width of the pulse width modulation ratio is minute. That is, the driving method of the liquid crystal display according to the exemplary embodiment shown in FIG. 11 more minutely changes the pulse width.

Accordingly, as shown in FIG. 12, the signal added to the feedback terminal FB of the DC-DC convertor 400 through the low pass filter changes more minutely than the steps illustrated in FIG. 8. That is, the signal appears to have a linear shape, and not the step shape. For example, the signal may be a ramp voltage or have a linear shape with a fixed slope.

Therefore, referring to FIG. 13, the voltage applied to the upper lens electrode 310 of the liquid crystal lens is also increased with the linear shape, and not the step shape. That is, the voltage applied to the upper lens electrode 310 of the liquid crystal lens is linearly increased from the VEE to the Vcom. An oblique angle shown in the graph is formed by gathering a plurality of stairs actually having the minute steps, as shown by a dotted line in FIG. 13.

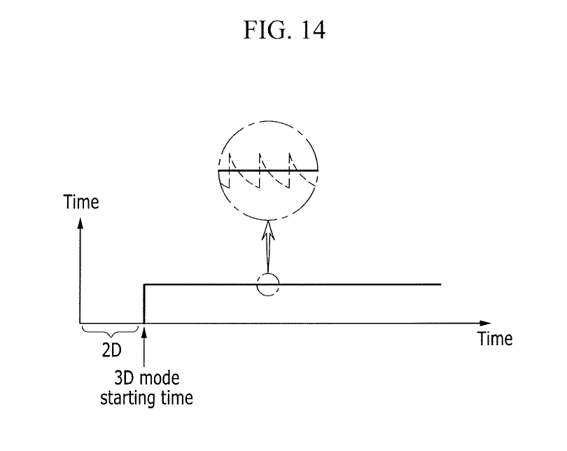

FIG. 14 shows the voltage applied to the upper lens electrode 310 when converting a liquid crystal lens from a 2D mode into a 3D mode. Accordingly, referring to FIG. 14, the current charged to the upper lens electrode 310 of the liquid crystal lens is constant without the peak. The current graph of FIG. 14 is formed by actually gathering a plurality of minute peaks as shown in FIG. 14.

The integral area of the current graph of FIG. 5B according to the comparative example, the integral area of the current graph of FIG. 4B according to an exemplary embodiment of the present invention, and the integral area of the current graph of FIG. 14 according to the exemplary embodiment of the present invention may all be the same. That is, the driving method according to the comparative example starts the 3D mode and simultaneously the overcurrent occurs within a short time, and in contrast, the driving method according to the exemplary embodiment of the invention slowly flows the current of the same amount during the constant time, thereby preventing the overload of the device. A time in which the current is applied is a very short time (e.g., several hundred milliseconds) so that the viewer cannot recognize the step change. Accordingly, the driving method according to the exemplary embodiment of the present invention substantially suppresses the overload of the device and reduces the capacity of the DC power source unit and the DC-DC convertor while preventing inconvenience to the viewer.

A liquid crystal lens panel according to an exemplary embodiment of the present invention will be described with reference to FIG. 15. FIG. 15 shows a structure of the liquid crystal lens panel according to an exemplary embodiment of the present invention.

Referring to FIG. 15, the liquid crystal lens panel according to an exemplary embodiment of the present invention includes a DC power source unit 150 supplying a power source to the liquid crystal lens, a DC-DC convertor 400, a voltage controller 500 connected to the DC-DC convertor 400, a plurality of driving ICs 600, and an electrode data generator 700 connected to the plurality of driving ICs.

Although not shown in FIG. 15, the DC power source unit 150, the DC-DC convertor 400, the voltage controller 500, the plurality of driving ICs 600, the electrode data generator 700, and like may be formed on one side of the lower substrate of the liquid crystal lens. Also, they may be formed on both sides of the lower substrate.

The DC power source unit 150 is connected to the DC-DC convertor 400 and generates and supplies a predetermined DC power source voltage to the DC-DC convertor 400.

The DC-DC convertor 400 is connected to a plurality of driving ICs 600 to convert the DC power source voltage supplied from the DC power source unit 150 into the predetermined DC voltage and to supply it to the plurality of driving ICs 600. In FIG. 15, one driving IC is shown, however a plurality of driving ICs may be provided.

The driving IC 600 receives and supplies the voltage applied to each electrode from the electrode data generator 700 to the lens electrode. The electrode data generator 700 stores information of the voltage to be applied to the separate lower lens electrode so that the liquid crystal lens may be operated with the Fresnel lens. The driving IC 600 supplies this information from the electrode data generator 700 to apply the voltage to the lower lens electrode 300.

Also, the driving IC 600 applies the voltage to the upper lens electrode 310 made of the plate. The voltage applied to the upper lens electrode 310 is controlled through the voltage controller 500 connected to the DC-DC converter 400.

The voltage controller 500 includes the control signal generator 510 and the low pass filter, and when the voltage controller 500 is converted from a 2D image mode into a 3D stereoscopic image mode, the method of applying the common voltage to the upper lens electrode is the same as described above.

That is, the voltage controller 500 gradually changes the control signal in the control signal generator 510 using the pulse width modulation method to gradually apply the voltage.

When displaying the 2D image, the constant logic high signal is generated in the control signal generator 510. This signal is applied to the feedback terminal FB of the DC-DC convertor 400. The DC-DC convertor 400 receives the logic high signal such that the output voltage is previously recognized to be excessive, and thereby the voltage is not output. Accordingly, the voltage is not applied to the electrode of the liquid crystal lens and the liquid crystal lens is not operated, and thereby the 2D image is displayed.

However, when displaying the 3D stereoscopic image, the control signal generator 510 gradually changes the logic high signal into the logic low signal through the PWM modulation method. Accordingly, the logic high signal supplied to the DC-DC convertor 400 is decreased into the logic low signal such that the DC-DC convertor 400 recognizes the output voltage to be reduced, and thereby the voltage is output. The control signal is gradually changed by the PWM modulation method such that the output voltage is gradually increased in stages (e.g., nonlinear steps). When the step change width of the PWM modulation ratio is small, the output voltage may be linearly increased, not in stages.

The output voltage is applied to the upper lens electrode 310 through the driving IC 400 such that the liquid crystal lens is turned on, and thereby the 3D stereoscopic image is displayed.

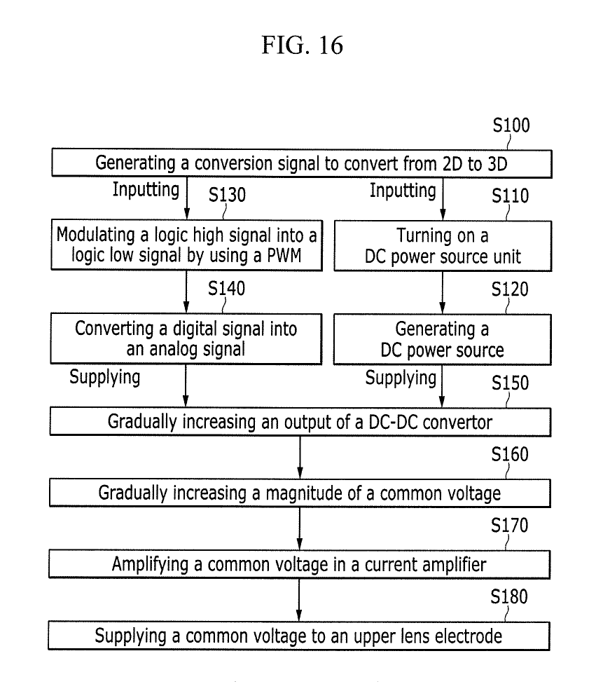

A voltage application method of the upper lens electrode 310 of the liquid crystal lens in the display device according to the present invention will be described in detail with reference to FIG. 16. FIG. 16 is a flowchart of a voltage application method of an upper lens electrode 310 of a liquid crystal lens.

Referring to FIG. 16, when changing the display device from the 2D image mode into the 3D stereoscopic image mode, the signal converting 2D into 3D is generated (S100). This signal may be applied by an external remote controller or an external input terminal.

The generated signal is input to the DC power source unit and the voltage controller positioned on the liquid crystal lens panel 50.

The DC power source unit receives the conversion signal to be turned on (S110), and the DC power source supplied to the liquid crystal lens panel is generated (S120). The generated DC power source may be in a range from 11 V to 13 V, but is not limited thereto.

On the other hand, the power source controller transmitted with the conversion signal converts the logic high signal into the logic low signal by using the pulse width modulation in the control signal generator positioned in the power source controller (S130).

The low pass filter connected to the control signal generator is provided in the power source controller. The low pass filter converts the digital signal generated in the control signal generator into the analog signal (S140).

The DC power source and the modulation signal generated in the power source controller are supplied to the DC-DC convertor 400. The DC-DC convertor 400 receives the modulation signal to gradually increase the output (S150).

As the output of the DC-DC convertor 400 is gradually increased, the magnitude of the common voltage generated from the DC-DC convertor 400 is gradually increased (S160). In an exemplary embodiment, the final magnitude of the common voltage is a middle voltage between the lowest voltage and the highest voltage that are applied to the liquid crystal lens. The increasing shape of the common voltage may be the step shape or the linear shape according to the pulse width modulation ratio.

The generated common voltage is supplied to the current amplifier to be amplified (S170). The current amplifier is connected to the upper lens electrode 310 and the amplified common voltage is supplied to the upper lens electrode (S180).

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the disclosure.

What is claimed is:

1. A display device comprising:
a display panel configured to display an image; and
a liquid crystal lens panel operated in one of a two dimensional (2D) mode to enable perception of the image as a 2D image and a 3D mode to enable perception of the image as a 3D image,
wherein the liquid crystal lens panel comprises:
a lower substrate and an upper substrate facing each other;
a lower lens electrode formed on the lower substrate;
an upper lens electrode formed on the upper substrate, and
a liquid crystal layer interposed between the lower substrate and the upper substrate,
wherein when the liquid crystal lens panel is converted from the 2D mode to the 3D mode, a voltage applied to the upper lens electrode of the liquid crystal lens is increased in stages.

2. The display device of claim 1, wherein the display panel is one of a liquid crystal display (LCD) panel, an electrophoretic display panel (EDP), an organic light emitting display (OLED) panel, and a plasma display panel (PDP).

3. The display device of claim 1, wherein
the lower lens electrode is divided into a plurality of lower lens electrode groups,
a width of each lower lens electrode in one lower lens electrode group is gradually widened from a boundary of the lower lens electrode group to a center, and
the upper lens electrode is formed of one plate.

4. The display device of claim 1, wherein
the liquid crystal lens panel includes a DC-DC convertor formed on one side of the lower substrate, and
a plurality of driving ICs connected to the DC-DC convertor,
wherein the plurality of driving ICs are connected to the lower lens electrode and the upper lens electrode.

5. The display device of claim 1, wherein
the DC-DC convertor supplies a voltage to the lower lens electrode and a common voltage to the upper lens electrode, and
an external signal is applied to a feedback terminal of the DC-DC convertor to gradually increase the common voltage applied to the upper lens electrode in the DC-DC convertor.

6. The display device of claim 1, wherein
the liquid crystal lens panel includes a voltage controller connected to a feedback terminal of the DC-DC convertor, and
the voltage controller outputs different logic signals according to the 2D mode or the 3D mode to be supplied to the DC-DC convertor.

7. The display device of claim 6, wherein
the voltage controller outputs the logic high signal in the 2D mode to suppress the output of the common voltage of the DC-DC convertor, and
the voltage controller outputs the logic low signal in the 3D mode to output the common voltage through the DC-DC convertor.

8. The display device of claim 7, wherein when the voltage controller converts the liquid crystal lens panel from the 2D mode into the 3D mode, the DC-DC convertor increases the common voltage applied to the upper lens electrode in stages by using a pulse width modulation method (PWM).

9. The display device of claim 3, wherein
the liquid crystal lens does not apply the voltage to the upper lens electrode and the lower lens electrode of the liquid crystal lens in the 2D mode, and
a different voltage is applied to each lower lens electrode included in the lower lens electrode group of the lower lens electrode and the common voltage of a predetermined magnitude is applied to the upper lens electrode in the 3D mode.

10. The display device of claim 7, wherein when the voltage controller performs a mode conversion from the 2D mode to the 3D mode, the DC-DC convertor linearly increases the common voltage applied to the upper lens electrode by using a pulse width modulation method (PWM).

11. A method of driving a display device, the method comprising:
generating a conversion signal converting a display device from a 2D image mode to a 3D image mode;
applying the conversion signal to a DC power source unit and a voltage controller of the liquid crystal lens panel;
turning on the DC power source unit of the liquid crystal lens applied with the conversion signal and supplying the DC power source to a DC-DC convertor;
modulating a logic high signal into a logic low signal in the voltage controller applied with the conversion signal by using a pulse width modulation method;
supplying the modulated signal to the DC-DC convertor through a feedback terminal of the DC-DC convertor;
gradually increasing an output of the DC-DC convertor supplied with the modulated signal to generate a common voltage that is gradually increased;
passing the common voltage formed in the DC-DC convertor through a current amplifier; and
supplying the common voltage passing through the current amplifier to the upper lens electrode.

12. The method of claim 11, wherein the DC power source supplied from the DC power source unit to the DC-DC converter is in a range from 11 V to 13 V.

13. The method of claim 11, wherein the common voltage generated in the DC-DC convertor is increased with a step shape.

14. The method of claim 11, wherein the common voltage generated in the DC-DC convertor is increased with a linear shape.

15. The method of claim 11, wherein the common voltage that is finally formed in the DC-DC convertor is a middle voltage between a lowest voltage and a highest voltage that are applied to the liquid crystal lens panel.

16. The method of claim 11, wherein the modulating of the logic high signal into the logic low signal in the voltage controller applied with the conversion signal by using a pulse width modulation method comprises:
forming the logic high signal or the logic low signal of a digital signal in a control signal generator located within the voltage controller; and
converting the digital signal into an analog signal in a low pass filter connected to the control signal generator.

17. A display device comprising:
a display panel configured to display an image; and
a liquid crystal lens panel operated in one of a two dimensional (2D) mode to enable perception of the image as a 2D image and a 3D mode to enable perception of the image as a 3D image,
wherein the liquid crystal lens panel comprises:
a lower substrate and an upper substrate facing each other;
a lower lens electrode formed on the lower substrate;
an upper lens electrode formed on the upper substrate, and
a liquid crystal layer interposed between the lower substrate and the upper substrate,
wherein when the liquid crystal lens panel is operated in the 2D mode , a first voltage of a constant level is applied to the upper lens electrode, and
wherein when the liquid crystal lens panel is switched from the 2D mode into the 3D mode, a second voltage that increases linearly with time from the constant level is applied to the upper lens electrode.

18. The display device of claim 17,
wherein the upper lens electrode is shaped as a single plate, and
wherein the lower lens electrode includes a plurality of separate elements spaced apart from one another.

19. The display device of claim 18, wherein an area of the upper lens electrode corresponds to an entire screen area of the display panel.

20. The display device of claim 18, wherein the separate elements comprise:
a first plurality of lens electrodes whose width gradually increasing widths; and
a second plurality of lens electrodes with gradually increasing widths disposed on the first plurality of lens electrodes.
